(19) United States
(12) Patent Application Publication
(10) Pub. No.: US 2008/0198161 A1
(43) Pub. Date: Aug. 21, 2008

(54) TISSUE STIFFNESS ASSIGNMENT

(75) Inventors: Thomas Schiwietz, Muenchen (DE); Joachim Georgii, Ismaning (DE); Rudiger Westermann, Karlsfeld (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Corporate Research, Inc., Princeton, NJ (US)

(21) Appl. No.: 12/031,246

(22) Filed: Feb. 14, 2008

Related U.S. Application Data
(60) Provisional application No. 60/889,988, filed on Feb. 15, 2007.

(51) Int. Cl. G06T 17/00

(52) U.S. Cl. 345/424

(57) ABSTRACT

A method for assigning stiffness values to voxels of an inputted discretized image includes assigning stiffness values according to intensity values of voxels of the image, wherein the inputted discretized image comprises the intensity values and refining the stiffness values assigned to voxels using a segmentation.

### CROSS-REFERENCE TO RELATED APPLICATION

This application claims priority to U.S. Provisional Application Ser. No. 60/889,988, filed on Feb. 15, 2007, which is herein incorporated by reference in their entirety.

### BACKGROUND OF THE INVENTION

1. Technical Field

The present invention relates to deforming images, and more particularly to a system and method for assigning tissue stiffness(es) to an image for use in deforming images using physical models comprising the assigned tissue stiffness.

2. Discussion of Related Art

Physics-based deformation techniques for volumetric bodies have a long tradition in computer animation and medical imaging. Less accurate finite difference and mass-spring models have been considered as well as more complicated and physically accurate finite element techniques.

An example of a physics-based deformation technique is the as-rigid-as-possible image deformation, which produce intuitive results when a user wants to manually control the shape deformation of an image. As-rigid-as-possible transformations, introduced for the purpose of shape interpolation, are characterized by a minimum amount of scaling and shearing. Such transformations mimic the adaptation of the mechanical properties (e.g., the stiffness) of the transformation to enforce rigidity.

Although as-rigid-as-possible transformations are well suited for the purpose of shape preservation they are not effective at following physics-based constraints like volume preservation or elastic deformations. As images are typically composed of parts, the stiffness of the transformation may need repeated adjustments to permit larger displacements over parts that are known to be compliant and smaller displacements over parts that are known to be less compliant. No known system or method exits for automatic stiffness assignment.

Therefore, a need exists for a physics-based deformation using stiffness assignment.

### SUMMARY OF THE INVENTION

According to an embodiment of the present disclosure, a method for assigning stiffness values to voxels of an inputted discretized image includes assigning stiffness values according to intensity values of voxels of the image, wherein the inputted discretized image comprises the intensity values and refining the stiffness values assigned to voxels using a segmentation.

According to an embodiment of the present disclosure, a method for assigning stiffness values to voxels of an inputted discretized image having seed points includes determining a probability that a random walker reaches a seed pixel from each pixel of the inputted discretized image, multiplying probabilities along a path of the random walker to the seed pixels, and mapping the segmentation probability distribution to stiffness values of voxels of the inputted discretized image.

According to an embodiment of the present disclosure, a system for assigning stiffness values to an image includes a memory device storing a plurality of instructions embodying the system for assigning stiffness values to the image and a discretized image having known intensity values at each voxel and a processor for receiving the discretized image and executing the plurality of instructions to perform a method including assigning stiffness values according to intensity values of the voxels, wherein the discretized image comprises the intensity values and refining the stiffness values assigned to the voxels using a segmentation.

### BRIEF DESCRIPTION OF THE DRAWINGS

Preferred embodiments of the present invention will be described below in more detail, with reference to the accompanying drawings:

FIG. 1 is an exemplary view of an image discretized into finite elements according to an embodiment of the present disclosure;

FIG. 2 is a flow chart of a method for image deformation using physical models including stiffness assignments according to an embodiment of the present disclosure;

FIG. 3 is a flow chart of a method for stiffness assignment using a transfer function, according to an embodiment of the present disclosure;

FIG. 4 is a flow chart of a method for stiffness assignment using a non-binary segmentation, according to an embodiment of the present disclosure;

FIG. 5 is a flow chart of a method for stiffness assignment, according to an embodiment of the present disclosure;

FIG. 6 is a diagram of a system according to an embodiment of the present disclosure.

### DETAILED DESCRIPTION OF EXEMPLARY EMBODIMENTS

According to an embodiment of the present disclosure, material stiffness is assigned to portions of images and volumes. The assignment may be manual, semi-automatic or fully-automatic.

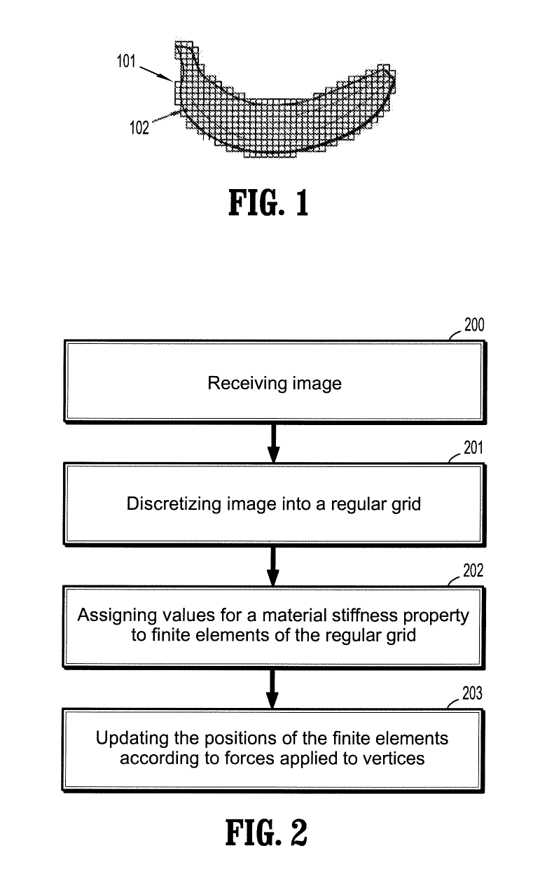

In physics-based simulations, stiffness can be assigned to each finite element in the simulation grid. FIG. 1 illustrates the grid of finite elements, e.g., 101, overlaid on an image 102. For example, a linear elasticity model can be implemented with constraints enforced to mimic plasticity, as an elastic material to resist a change in shape. For the linear elasticity model, it is assumed that the image is to be represented as a 2D triangular grid, where exactly one grid point is placed at each pixel center. Grid points are then connected to their one-ring neighbors via edges. Given such a grid in the reference configuration xεΩ, the deformed grid is modeled using a displacement function u(x),u: [symbol] ²→ [symbol] ² yielding the deformed configuration x+u(x). Triangular finite elements may be replaced by quadrangular elements to further an optimization.

One dimensional transfer functions can be used for assigning stiffness automatically. The one dimensional transfer functions are not applicable to unique intensity-tissue mapping, especially in regions with Houndsfield units close to that of water. To achieve more accurate tissue stiffness assignments a painter and/or a segmentation algorithm, such as a Random Walker, can be used to assign or refine stiffness values. A paint-and-fill interface of the painter may be used to assign stiffness to the image manually.

Referring to FIG. 2, physically based deformation algorithms simulate material or tissue deformations for a given image 200 according to real-world stiffness parameters. Finite elements like triangles or tetrahedrons are used to discretize continuous objects 201 (see for example, FIG. 1). The finite elements are connected by shared vertices and each finite element has a material stiffness property 202, to which a value may be assigned. A simulation engine updates the positions of the finite elements according to internal and external forces applied to the vertices 203, for example, using an implicit multi-grid solver for image deformations. Using smaller finite elements the overall object behavior is enhanced by more accurate stiffness assignments. Methods for computer graphics rendering, volume visualization, and/or image segmentation are used for stiffness assignment.

A physically correct deformation of a medical image can be achieved using physically-based simulation engines with finite elements. For improving accuracy, the finite elements should be substantially the same size as a voxel or smaller. For realistic deformations, the stiffness assigned to each finite element needs to substantially match a real tissue stiffness of the tissue being imaged/simulated. A typical image from a Computed Tomography (CT) or Magnetic Resonance (MR) scanner includes intensities that cannot be mapped to tissue types uniquely, for example, the low-intensity values indicate higher water density but do not yield information about the tissue and organ type.

According to embodiments of the present disclosure, different methods may be used for stiffness assignment.

According to an embodiment of the present disclosure, tissue stiffness can be assigned using a paint tool, e.g., an image editor or application. The user selects a voxel, e.g., using a brush took of the application, and assigns a tissue stiffness to the selected voxel. This procedure is repeated for all voxels.

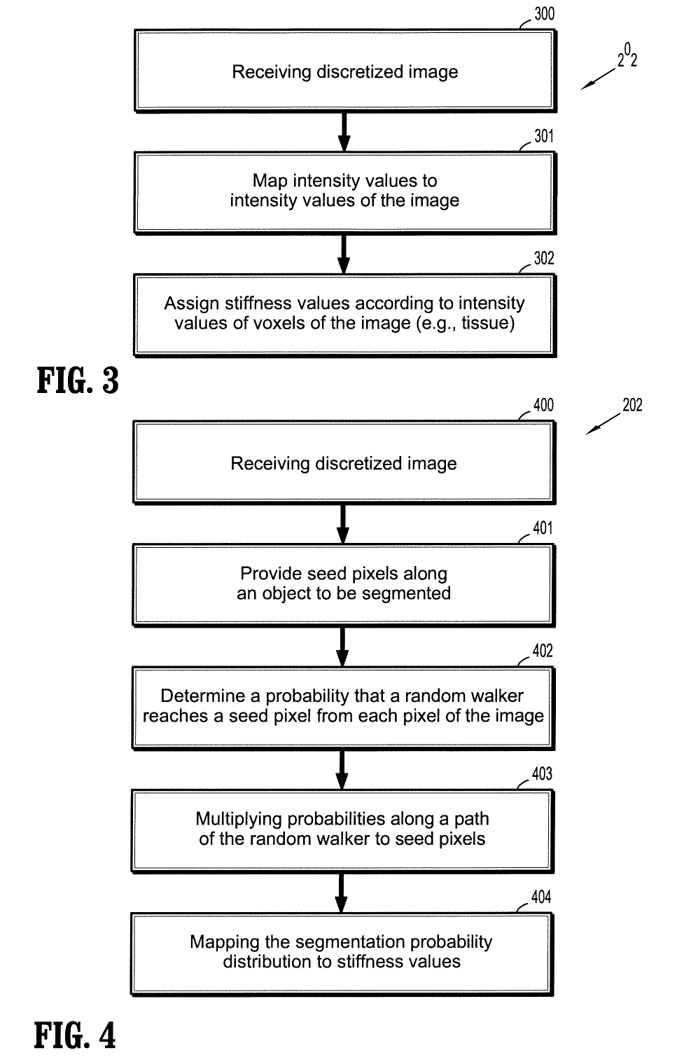

Referring to FIG. 3, according to an embodiment of the present disclosure, a transfer function, such as a ramp transfer function, can be used to assign stiffness. For a given image 300, a one dimensional transfer function maps intensity values to values, e.g., intensities, in a visualization 301. The transfer function can be arbitrary or use a window function. In images from CT scanners, high-intensity values refer to high energy absorption implying hard tissue types like bones for example. The low-intensity values indicate higher water density but not yield no clue about the tissue and organ type. For a number of deformation and registration problems a transfer function outputs registration based on deformation of tissue 302, e.g., a bone should remain un-deformed while the soft tissue should deform. The transfer function provides a fast and easy-to-use semi-automatic stiffness assignment tool.

According to an embodiment of the present disclosure, segmentation methods, such as a Random Walker, are used for stiffness assignment. The segmentation method may be applied individually or in connection with another method such as the transfer function, wherein for example, the segmentation method refines stiffness assignments determined by the transfer function for portions of the inputted image having low-intensity values. Referring to FIG. 4, segmentation algorithms like the Random Walker algorithm are used to segment the volume. The segmented volume part is assigned a specific tissue stiffness. Here, whole organs can be assigned stiffness values instead of single voxels. Any kind of segmentation algorithm can be used for this task. Non-binary segmentation algorithms like the Random Walker map the segmentation probabilities to stiffness values directly resulting in smooth stiffness transition between tissue types.

For an image to be segmented 400, seed pixels are provided 402, e.g., by a user, indicating an object to segment. A Random Walker algorithm starts on the image at the seed pixels. Given a random walker starting at every other pixel, a probability that the random walker reaches a seed pixels is determined 403. A direction of travel of the random walker is determined by the image structure. A change in pixel intensity is a measure for the probability by which the random walker crosses over to a neighboring pixel. Therefore, there is a high likelihood for the random walker to move inside the object being segmented, but low likelihood to cross the object's boundary. Probabilities computed along the paths from pixels to seed points are multiplied 403, which yields a probability distribution representing a non-binary segmentation. The segmentation probabilities are mapped to stiffness values for the object 404. For example, segmentation probabilities [0;1] can be mapped to a user-defined stiffness range (e.g., [10̂5 to 10̂8]). One of ordinary skill in the art would appreciate that the mapping may be modified for different implementations. The mapping is performed for all voxels of an image of interest, or a portion thereof.

To use the Random Walker algorithm on color images RGB pixel values are converted to intensity values. Pixel values are transformed to the Lab color space and the Euclidian length of the Lab vector length is used as intensity. A function to express the probability is defined to map changes in image intensities to crossing weights.

Thus, random walks are expressed by a system of linear equations. With the seed points as boundary conditions the problem can be posed as the solution of a sparse, symmetric, positive-definite system of linear equations.

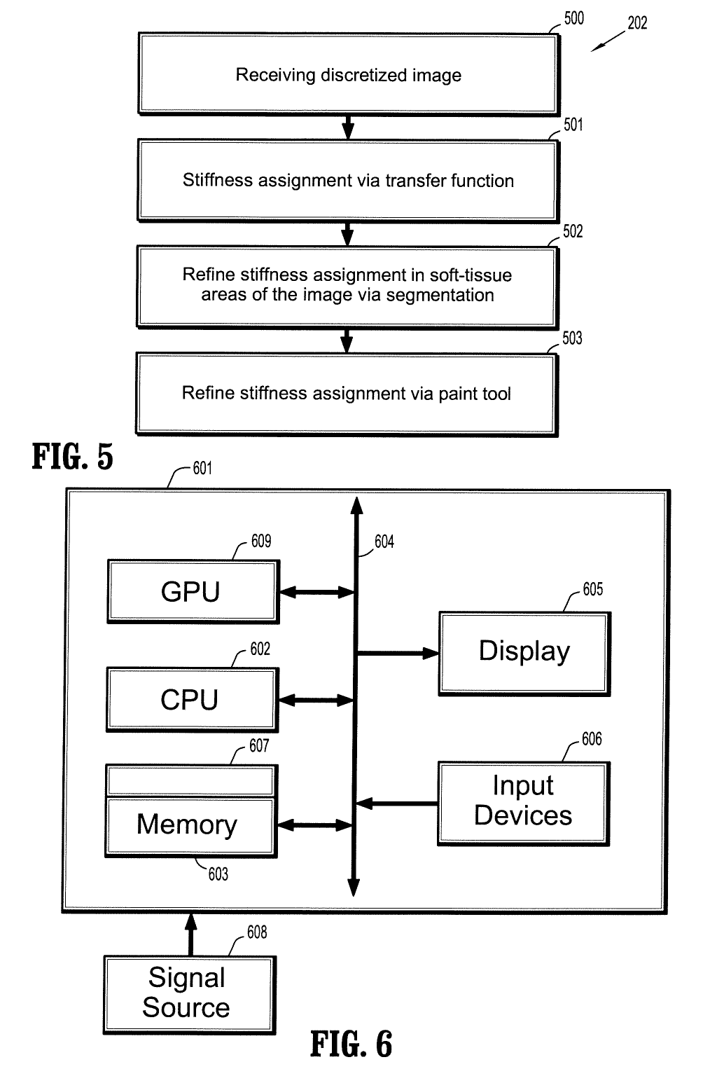

Referring to FIG. 5, according to an embodiment of the present disclosure, to assign tissue stiffness a combination of the paint tool, transfer function and random walker stiffness assignment methods can be implemented resulting in the following workflow: a rough stiffness assignment is performed on a given image 500 by a transfer function 501. The stiffness assignment is refined in for voxels having low intensity values, which are soft tissue areas, using a segmentation algorithm 502. A threshold for the low intensity values is used, for example, as set by a user or an automatic thresholding method for a given image. The threshold may be, for example, set to distinguish bone from other tissue. A user can further refine the assignment using the paint tool 503 to output the image having stiffness values assigned to different areas (e.g., tissues) of the image.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture.

Referring to FIG. 6, according to an embodiment of the present invention, a computer system 601 for assigning tissue stiffness comprise, inter alia, a central processing unit (CPU) 602, a memory 603 and an input/output (I/O) interface 604. The computer system 601 is generally coupled through the I/O interface 604 to a display 605 and various input devices 606 such as a mouse and keyboard. The support circuits can include circuits such as cache, power supplies, clock circuits, and a communications bus. The memory 603 can include random access memory (RAM), read only memory (ROM), disk drive, tape drive, etc., or a combination thereof. The present invention can be implemented as a routine 607 that is stored in memory 603 and executed by the CPU 602 to process a signal, e.g., a closed surface mesh, from the signal source 608. As such, the computer system 601 is a general purpose computer system that becomes a specific purpose computer system when executing the routine 607 of the present invention. The computer system 601 may further include a GPU 609 for processing certain operations.

The computer platform 601 also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

Having described embodiments for a system and method assigning tissue stiffness, it is noted that modifications and variations can be made by persons skilled in the art in light of the above teachings. It is therefore to be understood that changes may be made in the particular embodiments of the invention disclosed which are within the scope and spirit of the invention as defined by the appended claims. Having thus described the invention with the details and particularity required by the patent laws, what is claimed and desired protected by Letters Patent is set forth in the appended claims.

What is claimed is:

1. A computer readable medium embodying instructions executable by a processor to perform a method for assigning stiffness values to voxels of an inputted discretized image comprising:
computer-executable instructions for assigning stiffness values according to intensity values of voxels of the image, wherein the inputted discretized image comprises the intensity values; and
computer-executable instructions for refining the stiffness values assigned to voxels using a segmentation.

2. The system of claim 1, wherein forces are to the inputted discretized image having stiffness values assigned to voxels upon receiving an input command for dragging at least one voxel, the system further comprising:
computer-executable instructions for updating a mesh deformation of the inputted discretized image according to the forces; and
computer-executable instructions for wrapping the inputted discretized image according to a deformed mesh to produce a deformed image.

3. The system of claim 1, wherein seed pixels are provided on the image, the system further comprising:
computer-executable instructions for determining a probability that a random walker reaches a seed pixel from each pixel of the inputted discretized image;
computer-executable instructions for multiplying probabilities along a path of the random walker to the seed pixels; and
computer-executable instructions for mapping the segmentation probability distribution to stiffness values of voxels of the inputted discretized image.

4. The system of claim 1, further comprising:
computer-executable instructions for selecting voxels having low-intensity values for the refinement.

5. The system of claim 1, further comprising:
computer-executable instructions for a paint tool for manually refining stiffness assignments.

6. A computer readable medium embodying instructions executable by a processor to perform a method for assigning stiffness values to voxels of an inputted discretized image having seed points comprising:
computer-executable instructions for determining a probability that a random walker reaches a seed pixel from each pixel of the inputted discretized image;
computer-executable instructions for multiplying probabilities along a path of the random walker to the seed pixels; and
computer-executable instructions for mapping the segmentation probability distribution to stiffness values of voxels of the inputted discretized image.

7. The system of claim 6, further comprising:
applying forces to the inputted discretized image having stiffness values assigned to the voxels upon receiving an input command for dragging at least one voxel;
computer-executable instructions for updating a mesh deformation of the inputted discretized image according to the forces; and
computer-executable instructions for wrapping the inputted discretized image according to a deformed mesh to produce a deformed image.

8. The system of claim 6, wherein the inputted discretized image includes stiffness assignments determined by a transfer function, the system comprising computer-executable instructions for selecting voxels of the inputted discretized image having low-intensity values for refinement by using the random walker.

9. A system for assigning stiffness values to an image comprising:
a memory device storing a plurality of instructions embodying the system for assigning stiffness values to the image and a discretized image having known intensity values at each voxel; and
a processor for receiving the discretized image and executing the plurality of instructions to perform a method comprising:
assigning stiffness values according to intensity values of the voxels, wherein the discretized image comprises the intensity values; and
refining the stiffness values assigned to the voxels using a segmentation.

10. The system of claim 9, wherein the processor further performs method steps comprising:
applying forces to the discretized image having stiffness values assigned to voxels upon receiving an input command for dragging at least one pixel;
updating a mesh deformation of the discretized image according to the forces; and
wrapping the discretized image according to a deformed mesh to produce a deformed image.

10. The system of claim 9, wherein seed pixels are provided on the image and the processor further performs method steps of the refinement comprising:
determining a probability that a random walker reaches a seed pixel from each pixel of the discretized image;
multiplying probabilities along a path of the random walker to the seed pixels; and
mapping a segmentation probability distribution to stiffness values of voxels of the inputted discretized image.

11. The system of claim 10, wherein the processor further performs method steps comprising selecting voxels having low-intensity values for the refinement.
